(19) United States
(12) Patent Application Publication
(10) Pub. No.: US 2015/0169677 A1
(43) Pub. Date: Jun. 18, 2015

(54) SYSTEM FOR FOLLOWING GOVERNMENTAL RULES AND RULEMAKING PROCESSES

(71) Applicant: Avraham Noiman, Boca Raton, FL (US)

(72) Inventor: Avraham Noiman, Boca Raton, FL (US)

(21) Appl. No.: 14/297,117

(22) Filed: Jun. 5, 2014

Related U.S. Application Data
(60) Provisional application No. 61/917,618, filed on Dec. 18, 2013.

(51) Int. Cl. G06F 17/30

(52) U.S. Cl. CPC G06F 17/30424; G06F 17/30321; G06F 17/30569

(57) ABSTRACT

A method on a server for providing information about laws and lawmaking processes over a communications network is disclosed. The method includes receiving law and lawmaking process data continuously in real-time, storing and indexing the law and lawmaking process data, providing a graphical user interface (GUI) for a user to enter a business, product or occupational definition, performing a search of the law and lawmaking process data using the definition that was entered, and storing any search results that comprise links to law and lawmaking process data that pertain to the definition, providing a GUI to the user for displaying the search results, tracking changes to the law and lawmaking process data of the search results, and sending a notification to the user reporting said changes to the law and lawmaking process data of the search results.

### CROSS-REFERENCE TO RELATED APPLICATIONS

This patent application claims priority to provisional patent application 61/917,618, filed Dec. 18, 2013, and entitled “System for Following Governmental Rules and Rulemaking Processes and Interacting with Governmental Entities,” which is hereby incorporated by reference in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### TECHNICAL FIELD

The technical field relates generally to information systems and, more specifically, to Web-based databases and servers pertaining to governmental legislative information.

### BACKGROUND

With the advent of the Internet and increasingly powerful computing devices, many private and public sector entities have moved to provide as much of their information online as possible, as quickly as possible. Amazon.com, Inc. is an example of a private sector entity that provides not only all of their retail sales information online, but also their internal information, such as quarterly reports and SEC filings. The U.S. Patent Office is an example of a public sector entity that provides all non-confidential proceedings online, as well as all internal data, such as employment related data and production statistics. The philosophy behind providing the aforementioned data online is that a better informed group of consumers will act in a more informed fashion, thereby increasing productivity, reducing costs and enhancing customer experiences.

One area that has not embraced this philosophy, however, is governmental legislative and rulemaking processes. Today, it is still difficult and complex for regular citizens to follow a proposed law through its lifecycle, from the legislative rulemaking process to a law on the books, and subsequent amendments thereof. Further, it is still challenging for citizens with no legal expertise to find out which laws or proposed laws currently affect or will affect the citizen, the citizen's business, the citizen's product, or the citizen's occupation. Also, there is little or no guidance provided by governmental organizations on how citizens can interact with the government so as to participate in governmental legislative and rulemaking processes. Lastly, there are no avenues available for citizens to identify and interact with other citizens and private entities that are affected by the same governmental legislative and rulemaking processes.

Therefore, a dire need exists for improvements over the prior art, and more particularly, there is a need for a consolidated method and system for allowing citizens to follows laws through their lifecycle, to find laws that affect their lives and to engage governmental entities in legislative and rulemaking processes, as well like-minded citizens and private entities.

### SUMMARY

According to the aspects illustrated herein, a method on a server for providing information about laws and lawmaking processes over a communications network is disclosed. The method includes: a) receiving, via the communications network, law data and lawmaking process data, wherein the receiving step is performed continuously in real-time; b) storing and indexing the law data and the lawmaking process data in a connected database, wherein the storing and indexing steps are performed continuously in real-time; c) providing, via the communications network, a graphical user interface for a user to enter a business, product or occupational definition; d) performing a search of the law data and the lawmaking process data in the connected database using the definition that was entered, and storing in the database any search results of the search that was performed, wherein the search results comprise links to law data and lawmaking process data that pertain to the definition; e) providing, via the communications network, a graphical user interface to the user for displaying the search results of the search that was performed; f) tracking, in the connected database, changes to the law data and the lawmaking process data of the search results; and g) sending, via the communications network, a notification to the user reporting said changes to the law data and the lawmaking process data of the search results.

This Summary is provided to introduce a selection of disclosed concepts in a simplified form that are further described below in the Detailed Description including the drawings provided. This Summary is not intended to identify key features or essential features of the claimed subject matter. Nor is this Summary intended to be used to limit the claimed subject matter's scope.

### BRIEF DESCRIPTION OF THE DRAWINGS

The accompanying drawings, which are incorporated in and constitute a part of this disclosure, illustrate various example embodiments. In the drawings:

FIG. 1 is a schematic block diagram of an operating environment of the present invention, according to an example embodiment.

FIG. 2 is a block diagram showing data flow during the process for following law data through its lifecycle and providing points of entry for interested citizens over a communications network, according to one embodiment of the present invention.

FIG. 3 is a block diagram showing data flow during the process of submitting profile data, according to one embodiment of the present invention.

FIG. 4 is a block diagram of a system including an example computing device 400 and other computing devices.

### DETAILED DESCRIPTION

The following detailed description refers to the accompanying drawings. Wherever possible, the same reference numbers are used in the drawings and the following description to refer to the same or similar elements. While the disclosed embodiments may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosed embodiments. Instead, the proper scope of the disclosed embodiments is defined by the appended claims.

In accordance with the embodiments described herein, the system for providing information about laws and lawmaking processes over a communications network overcomes shortcomings of the prior art by providing citizens with a comprehensive, all-inclusive forum for citizens and relevant participants of a jurisdiction on one centralized network hub via a communications network. The disclosed embodiments allow regular citizens and private entities to follow a proposed law through its lifecycle, from the legislative rulemaking process to a law on the books, and subsequent amendments thereof. Further, the disclosed embodiments allow citizens with no legal expertise to find out, on a regular basis, which laws or proposed laws currently affect or will affect the citizen, the citizen's business, the citizen's product, or the citizen's occupation. Also, the disclosed embodiments provide a forum for allowing citizens to easily interact with relevant governmental entities so as to participate in governmental legislative and rulemaking processes. Lastly, the disclosed embodiments provide a forum for citizens to identify and interact with other citizens and private entities that are affected by the same governmental legislative and rulemaking processes.

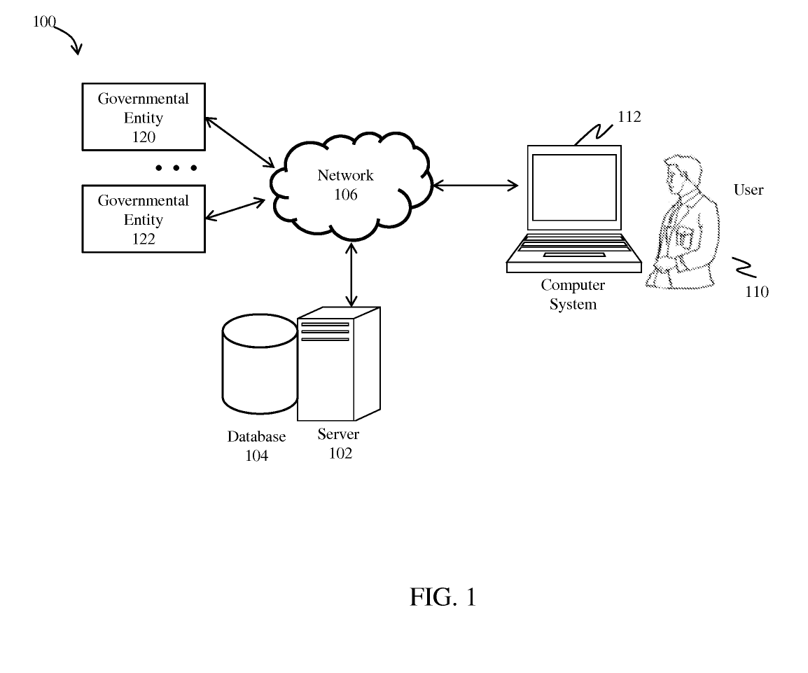

Referring now to the drawing figures in which like reference designators refer to like elements, there is shown in FIG. 1 a block diagram of an operating environment 100 of a system for providing information about laws and lawmaking processes over a communications network, in accordance to an example embodiment. A prominent element of FIG. 1 is the server 102 associated with a data repository or server-side database 104 and further coupled with network 106, which can be a circuit switched network, such as the Public Service Telephone Network (PSTN), or a packet switched network, such as the Internet or the World Wide Web, the global telephone network, a cellular network, a mobile communications network, a WAN, a LAN, or any combination of the above. Server 102 collects and manages data from the governmental entities 120, 122 and further manages the server-side database 104, which holds the master copy of data that is served to client computing device 112. The governmental entities 120, 122 may comprise entities of a government that produce law data and lawmaking process data, such as the U.S. Federal Register or the U.S. Government Printing Office.

FIG. 1 further includes client computing device 112, which may be a desktop computer, a common computer terminal or mobile computing devices such as smart phones, mobile phones, tablet computers, handheld computers, laptops, or the like. Device 112 corresponds to user or citizen 110. The server-side database 104 may, for example, be a relational database comprising a Structured Query Language (SQL) database stored in a SQL server. Server-side database 104 may be distributed over one or more nodes or locations that are connected via network 106. Client device 112 may also include its own client-side database.

FIG. 1 shows an embodiment wherein networked client computing device 112 interacts with server 102 and server-side database 104 over the network 106. Server 102 and client computing device 112 include a software engine that delivers applications, data, program code and other information to other computing devices via the network 106. FIG. 1 also shows an embodiment wherein networked governmental entities 120, 122 (servers) interact with server 102 and server-side database 104 over the network 106. It should be noted that although FIG. 1 shows only one server 102, one client computing device 112 and two governmental entities 120, 122, the system of the present invention supports any number of servers, governmental entities and client computing devices connected via network 106.

Server 102 and client computing device 112 include program logic comprising computer source code, scripting language code or interpreted language code that may be compiled to produce an executable file or computer instructions, or that may be interpreted at run-time, wherein the computer source code performs various functions of the present invention.

Note that although server 102 is shown as a single and independent entity, in one embodiment of the present invention, the functions of server 102 may be integrated with another entity, such as entities 120, 122. Further, server 102 and its functionality, according to a preferred embodiment of the present invention, can be realized in a centralized fashion in one computer system or in a distributed fashion wherein different elements are spread across several interconnected computer systems.

The database 104 is one or more data storage devices storing law data, law making process data, and user account information. As described in further detail below, the database 104 provides to hold law data, which may include for each law or governmental rule, the text of the law, the history of the law, comments related to the law, references to other laws, interpretations of the law, origins of the law, location of the law in the relevant books or publications, references to governmental entities tasked with forming the law, references to governmental entities tasked with amending the law, references to governmental entities tasked with enforcing the law, etc. Law data may be stored, for example, in ASCII format, XML format, Portable Document format (PDF) format, Universal Character Set Transformation Format 8-bit (UTF-8) format, etc. Law data may also include a certified copy of a law or a certified legal document, such as a certified PDF copy of a U.S. law provided by the US. Federal Register and/or the Government Printing Office, which publishes government notices, rule changes and executive orders. Law data may further include a summary of the law, such as a brief textual description of the law. Law data may also include a description of current changes to the law, such as deletions or additions to the text of the law that have just occurred due to legislative action.

Also as described in further detail below, the database 104 provides to hold law making process data for one or more laws, which may include for each law, previous versions of the text of the law, comments on previous versions of the law, arguments presented during hearings about the law, evidence and testimony presented during hearings regarding the law, historical data pertaining to the law, references to votes on the law, interpretations of the law over time, etc. Law making process data may further include a summary of the law making process data, such as a brief textual description of the data.

In one embodiment, law making process data may have a corresponding record in the database, wherein the record includes the lawmaking process data defined above, as well as law data or a link or reference to a record including law data. Likewise, each law or governmental rule may have a corresponding record in the database, wherein the record includes the law data defined above, as well as lawmaking process data or a link or reference to a record including lawmaking process data.

The database 104 may also hold a profile record for each user 110, wherein the profile record may include profile data comprising a user name, a user account password, personal information, professional information, service provider information, occupation information, contact information, business information, product information, demographic data, and other data relevant to the consumer. The profile record may also hold consumer profile data, business profile data and/or social media profile data that may be used at a point of entry to engage with a governmental entity 120, 122 or other users. First time users may create a new profile, including entering consumer information such as username, password, re-entering password and populating other applicable user information to be stored in the database 104. Existing users, who have already created a user account, may access the user account by re-entering user information such as username, password and/or other applicable user information. The server 102 will retrieve stored information from the database 104 for the existing user.

A profile record may also include a definition, such as a business, product or occupational definition. A definition describes an area of law in which the user 110 has an interest, whether it relates to the user's business, a product of the user or an occupation of the user. A definition may also include a numerical code that corresponds to predefined metadata. For example, a definition may include a North American Industry Classification System or NAICS code used by business and government to classify business establishments according to type of economic activity, or a Standard Industrial Classification (SIC) code used for classifying industries by a four-digit code. A numerical code is associated with a chart or lookup table that defines, for each code, the corresponding metadata, such as the type of economic activity or type of industry. INCLUDE OCL AND NAPCS Additional codes used to classify businesses according to business activity include the North American Product Classification System (NAPCS) and OCS codes.

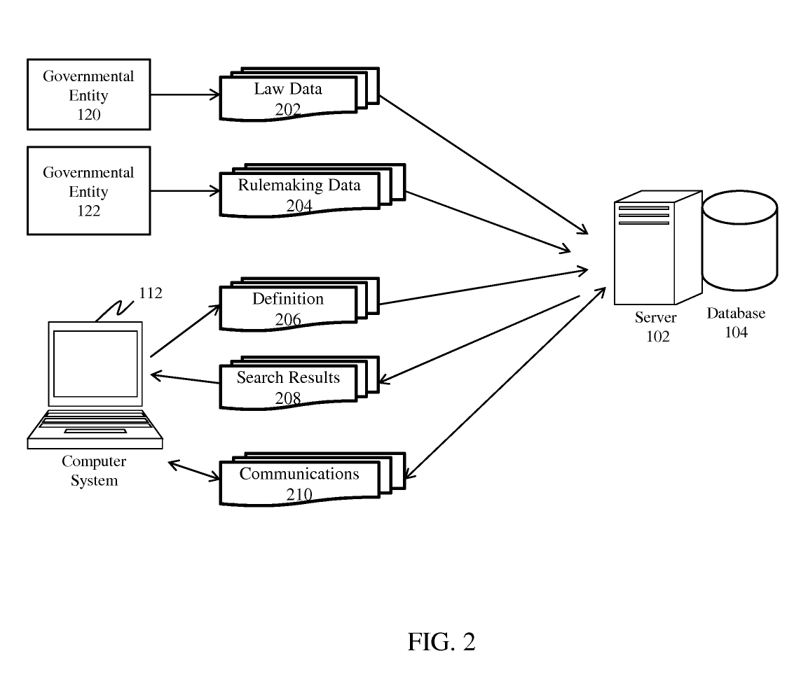

FIG. 2 is a block diagram showing data flow 200 during the process for following law data through its lifecycle and providing points of entry for interested users, citizens, and private entities over a communications network, according to the disclosed embodiments. In one embodiment, the server 102 is configured for continuously reading, in real time (or near real time), law data 202 and rulemaking data 204 from the governmental entities 120, 122. A real-time system, such as the one described herein, is one which controls an environment by receiving data, processing them, and returning the results sufficiently quickly to affect the environment at that time. As user herein, the term real time is used to mean without perceivable delay. The term near real time is used to mean with a perceivable, but still diminutive, delay.

During the data collection process, the server 102 reads data in real time from the governmental entities 120, 122, converts the data, formats the data, compresses the data, indexes the data and then stores the data in law data records or lawmaking process data records (as defined above) in database 104. During the data collection process, the server 102 may, for example, read the law data 202 in Portable Document format (PDF) format and convert it to Universal Character Set Transformation Format 8-bit (UTF-8) format, ASCII format, or XML format, and store it as such. During the data storage process, the server 102 may store all data it has collected relating to data 202 and 204, including references to the governmental entities from which the data originated, references to governmental entities tasked with forming the law, references to governmental entities tasked with amending the law, references to governmental entities tasked with enforcing the law, etc.

Server 102 is further configured for providing a graphical user interface for the consumer 110 (viewed on device 112) to enter a business, product, individual right or occupational definition 206. A definition describes an area of law in which the user 110 has an interest, whether it relates to the user's business, a product of the user or an occupation of the user. A definition may also include a numerical code that corresponds to predefined metadata. A definition 206 may further comprise one or more search parameters that define one or more aspects of the user 110's rights, business, products or occupations. Said rights may include a citizen's rights to participate in the lawmaking processes, the citizen's individual rights and the rights of any citizen to engage in certain activities.

Upon receiving the definition 206, the server 102 performs a search of the law data and the lawmaking process data in the database 104 using the definition 206 that was entered. The search results 208 may comprise links or references to the law data and the lawmaking process data in the database 104 matching, or most closely matching, the definition 206. The search results 208 may also comprise summaries of said law data and lawmaking process data. Subsequently, the server 102 stores search results 208 in the database 104, such as in association with the profile record of use 110. Then, the server 102 may provide said search results 208 to the consumer 110, such as via a graphical user interface viewed on device 112. In one embodiment, the law data 202 provided to the user includes a document comprising a certified copy of a law.

Subsequently, server 102 tracks changes to the law data 202 and the lawmaking process data 204 of the search results 208 and notifies the user 110 of said changes by transmitting an email, text message or other notification to device 112 of user 110. Alternatively, server 102 tracks changes to the law data 202 and the lawmaking process data 204 of the search results 208 and provides said changes to the consumer 110 over a graphical user interface viewed on device 112. Finally, server 102 provides a graphical user interface including social media functions and communications functions for the user to conduct communications 210 with governmental parties associated with the law data and the lawmaking process data of the search results 208.

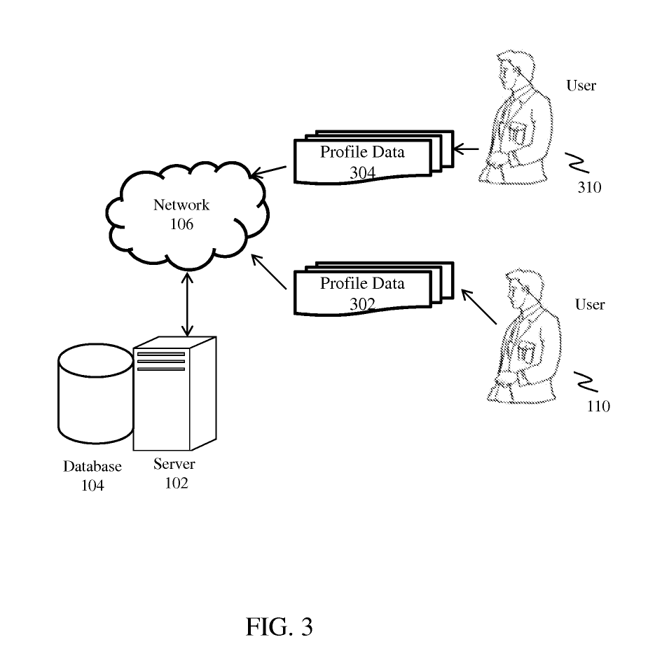

FIG. 3 is a block diagram showing data flow during the process of submitting profile data, according to one embodiment of the present invention. As an additional feature, server 102 provides a graphical user interface for the user 110 to enter profile data 302, which may comprise a consumer profile, business profile and/or social media profile that may be used at a point of entry to engage with a governmental entity 120, 122, as well as other users. Server 102 may also provide a graphical user interface for another user 310 to enter profile data 304. The profile data 302, 304 entered by each user may also include a business, product or occupational definition. The profile data 302, 304 may be stored in association with each user in the database 104. Server 102 may then perform a search in the connected database 104 for profile data matching the profile data entered by the users. Subsequently, the server 102 may provide, via the communications network 106, a graphical user interface for displaying search results of the search that was performed, wherein the search results comprise links to profile data matching the profile data entered by each user, as well as contact information for other users associated with said profile data. Thus, the server 102 acts to connect users with other users having similar interests in law data, lawmaking process data, profile data, etc.

In one embodiment, the server 102 is configured for publishing the consumer profiles, business profiles, social media profiles and other records in database 104 on a publicly available forum via the communications network 106. Server 102 also provides a graphical user interface via the communications network for allowing communications 210 between the users 310, 110 and entities 120, 122, as well as providing social network services to users and entities 120, 122.

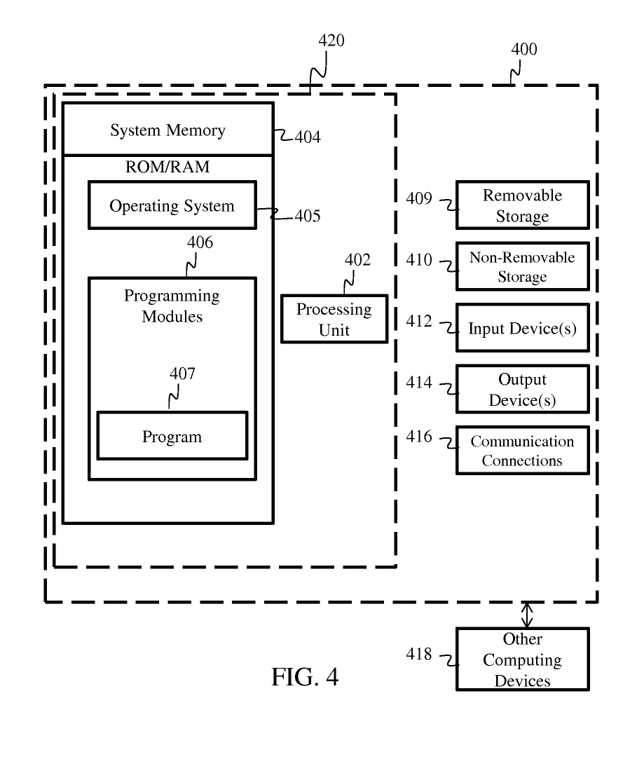

FIG. 4 is a block diagram of a system including an example computing device 400 and other computing devices. Consistent with the embodiments described herein, the aforementioned actions performed by server 102 may be implemented in a computing device, such as the computing device 400 of FIG. 4. Any suitable combination of hardware, software, or firmware may be used to implement the computing device 400. The aforementioned system, device, and processors are examples and other systems, devices, and processors may comprise the aforementioned computing device. Furthermore, computing device 400 may comprise an operating environment for the methods shown in FIGS. 2-3 above.

With reference to FIG. 4, a system consistent with an embodiment of the invention may include a plurality of computing devices, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination or memory. System memory 404 may include operating system 405, one or more programming modules 406 (such as program module 407). Operating system 405, for example, may be suitable for controlling computing device 400's operation. In one embodiment, programming modules 406 may include, for example, a program module 407. Furthermore, embodiments of the invention may be practiced in conjunction with a graphics library, other operating systems, or any other application program and is not limited to any particular application or system. This basic configuration is illustrated in FIG. 4 by those components within a dashed line 420.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e. memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a camera, a touch input device, etc. Output device(s) 414 such as a display, speakers, a printer, etc. may also be included. The aforementioned devices are only examples, and other devices may be added or substituted.

Computing device 400 may also contain a communication connection 416 that may allow device 400 to communicate with other computing devices 418, such as over a network in a distributed computing environment, for example, an intranet or the Internet. Communication connection 416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both computer storage media and communication media.

As stated above, a number of program modules and data files may be stored in system memory 404, including operating system 405. While executing on processing unit 402, programming modules 406 may perform processes including, for example, one or more of the methods shown in FIGS. 2-3 above. The aforementioned processes are examples, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip (such as a System on Chip) containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, or other forms of RAM or ROM. Further, the disclosed methods' stages may be modified in any manner, including by reordering stages and/or inserting or deleting stages, without departing from the invention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method on a server for providing information about laws and lawmaking processes over a communications network, comprising:
a) receiving, via the communications network, law data and lawmaking process data, wherein the receiving step is performed continuously in real-time,
wherein law data comprises text of a law, a history of the law, comments related to the law, references to other laws, interpretations of the law, references to governmental entities tasked with forming the law, references to governmental entities tasked with amending the law, references to governmental entities tasked with enforcing the law, a certified copy of the law, and a summary of the law consisting of a brief textual description, and
wherein lawmaking process data comprises previous versions of text of the law, comments on previous versions of the law, arguments presented during hearings about the law, evidence and testimony presented during hearings regarding the law, historical data pertaining to the law, references to votes on the law, interpretations of the law, and a summary of the law making process data consisting of a brief textual description;
b) storing and indexing the law data and the lawmaking process data in a connected database, wherein the storing and indexing steps are performed continuously in real-time;
c) providing, via the communications network, a graphical user interface for a user to enter a business, product or occupational definition;
d) performing a search of the law data and the lawmaking process data in the connected database using the definition that was entered, and storing in the database any search results of the search that was performed, wherein the search results comprise links to law data and lawmaking process data that pertain to the definition;
e) providing, via the communications network, a graphical user interface to the user for displaying the search results of the search that was performed;
f) tracking, in the connected database, changes to the law data and the lawmaking process data of the search results, wherein said changes comprises additions or deletions of text that occurred due to legislative action; and
g) sending, via the communications network, a notification to the user reporting said changes to the law data and the lawmaking process data of the search results.

2. The method of claim 1, wherein the step of receiving law data and lawmaking process data, further comprises:
receiving, via the communications network, law data and lawmaking process data, wherein the receiving step is performed continuously in real-time, and wherein the law data and lawmaking process data comprises document in the Portable Document Format (PDF) file format.

3. The method of claim 2, wherein the step of storing and indexing the law data and the lawmaking process data, further comprises:
converting the law data and the lawmaking process data into Universal Character Set Transformation Format 8-bit (UTF-8) format;
indexing the law data and the lawmaking process data in the connected database, wherein; and
storing the law data and the lawmaking process data in UTF-8 format in the connected database, wherein the converting, storing and indexing steps are performed continuously in real-time.

4. The method of claim 3, wherein the step of providing a graphical user interface for a user to enter a business, product or occupational definition, further comprises:
providing, via the communications network, a graphical user interface for a user to enter a business, product or occupational definition, wherein the definition includes: 1) a numerical code that corresponds to predefined metadata and 2) a definition of rights of the user, comprising a definition of a user's rights to participate in the lawmaking processes, the user's individual rights and the user's rights to engage in particular activities.

5. The method of claim 4, wherein the step of performing a search of the law data and the lawmaking process data, further comprises:
performing a search of the law data and the lawmaking process data in the connected database using the definition that was entered, and storing in the database any search results of the search that was performed, wherein the search results comprise links to law data and lawmaking process data that pertain to the definition, as well as summaries of the law data and lawmaking process data that pertain to the definition.

6. The method of claim 5, wherein the step of sending a notification to the user, further comprises:
sending, via the communications network, an email to the user reporting said changes to the law data and the lawmaking process data of the search results, wherein said changes comprise links to law data and lawmaking process data that pertain to the definition, as well as summaries of the law data and lawmaking process data that pertain to the definition.

7. The method of claim 1, further comprising:
h) providing, via the communications network, a graphical user interface for the user to enter profile data comprising contact information and a business, product or occupational definition, and storing said profile data in the connected database;
i) performing a search in the connected database for the profile data entered by the user; and
j) providing, via the communications network, a graphical user interface for displaying search results of the search that was performed for the profile data, wherein the search results comprise links to profile data matching the profile data entered by the user, as well as contact information for other users associated with said profile data.

8. The method of claim 1, further comprising:
k) providing, via the communications network, a graphical user interface including social media functions and communications functions for the user to conduct communications with other users having profile data matching the profile data entered by the user.

9. The method of claim 1, wherein the law data comprises a certified legal document.

10. The method of claim 1, wherein the law data comprises a certified legal document in the Portable Document Format (PDF) file format.

11. A computer system for providing information about laws and lawmaking processes over a communications network, the computer system comprising:
a database;
a memory;
a network interface device communicatively coupled with the communications network;
a processor communicatively coupled with the memory and the network interface device, the processor configured for:
a) receiving, via the communications network, law data and lawmaking process data, wherein the receiving step is performed continuously in real-time,
wherein law data comprises text of a law, a history of the law, comments related to the law, references to other laws, interpretations of the law, references to governmental entities tasked with forming the law, references to governmental entities tasked with amending the law, references to governmental entities tasked with enforcing the law, a certified copy of the law, and a summary of the law consisting of a brief textual description, and
wherein lawmaking process data comprises previous versions of text of the law, comments on previous versions of the law, arguments presented during hearings about the law, evidence and testimony presented during hearings regarding the law, historical data pertaining to the law, references to votes on the law, interpretations of the law, and a summary of the law making process data consisting of a brief textual description;
b) storing and indexing the law data and the lawmaking process data in a connected database, wherein the storing and indexing steps are performed continuously in real-time;
c) providing, via the communications network, a graphical user interface for a user to enter a business, product or occupational definition;
d) performing a search of the law data and the lawmaking process data in the connected database using the definition that was entered, and storing in the database any search results of the search that was performed, wherein the search results comprise links to law data and lawmaking process data that pertain to the definition;
e) providing, via the communications network, a graphical user interface to the user for displaying the search results of the search that was performed;
f) tracking, in the connected database, changes to the law data and the lawmaking process data of the search results, wherein said changes comprises additions or deletions of text that occurred due to legislative action; and
g) sending, via the communications network, a notification to the user reporting said changes to the law data and the lawmaking process data of the search results.

12. The computer system of claim 11, wherein the step of receiving law data and lawmaking process data, further comprises:
receiving, via the communications network, law data and lawmaking process data, wherein the receiving step is performed continuously in real-time, and wherein the law data and lawmaking process data comprises document in the Portable Document Format (PDF) file format.

13. The computer system of claim 12, wherein the step of storing and indexing the law data and the lawmaking process data, further comprises:
converting the law data and the lawmaking process data into Universal Character Set Transformation Format 8-bit (UTF-8) format;
indexing the law data and the lawmaking process data in the connected database, wherein; and
storing the law data and the lawmaking process data in UTF-8 format in the connected database, wherein the converting, storing and indexing steps are performed continuously in real-time.

14. The computer system of claim 13, wherein the step of providing a graphical user interface for a user to enter a business, product or occupational definition, further comprises:
providing, via the communications network, a graphical user interface for a user to enter a business, product or occupational definition, wherein the definition includes: 1) a numerical code that corresponds to predefined metadata and 2) a definition of rights of the user, comprising a definition of a user's rights to participate in the lawmaking processes, the user's individual rights and the user's rights to engage in particular activities.

15. The computer system of claim 14, wherein the step of performing a search of the law data and the lawmaking process data, further comprises:
performing a search of the law data and the lawmaking process data in the connected database using the definition that was entered, and storing in the database any search results of the search that was performed, wherein the search results comprise links to law data and lawmaking process data that pertain to the definition, as well as summaries of the law data and lawmaking process data that pertain to the definition.

16. The computer system of claim 15, wherein the step of sending a notification to the user, further comprises:
sending, via the communications network, an email to the user reporting said changes to the law data and the lawmaking process data of the search results, wherein said changes comprise links to law data and lawmaking process data that pertain to the definition, as well as summaries of the law data and lawmaking process data that pertain to the definition.

17. The computer system of claim 11, wherein the processor is further configured for:
h) providing, via the communications network, a graphical user interface for the user to enter profile data comprising contact information and a business, product or occupational definition, and storing said profile data in the connected database;
i) performing a search in the connected database the profile data entered by the user; and
j) providing, via the communications network, a graphical user interface for displaying search results of the search that was performed for the profile data, wherein the search results comprise links to profile data matching the profile data entered by the user, as well as contact information for other users associated with said profile data.

18. The computer system of claim 11, wherein the processor is further configured for:
k) providing, via the communications network, a graphical user interface including social media functions and communications functions for the user to conduct communications with other users having profile data matching the profile data entered by the user.
